(19) United States
(12) Patent Application Publication
(10) Pub. No.: US 2020/0408181 A1
(43) Pub. Date: Dec. 31, 2020

(54) AN ARRANGEMENT FOR PROTECTING A HIGH-PRESSURE ACCUMULATOR FUEL INJECTION SYSTEM

(71) Applicant: Scania CV AB, Södertälje (SE)

(72) Inventors: Kim KYLSTRÖM, Tullinge (SE); Ulf CARLSSON, Rönninge (SE)

(21) Appl. No.: 16/081,833

(22) PCT Filed: Feb. 2, 2017
(86) PCT No.: PCT/SE2017/050084

§ 371 Date: Aug. 31, 2018

(30) Foreign Application Priority Data
Mar. 7, 2016 (SE) 1650302-1

(51) Int. Cl. F02M 59/36; F02D 41/22; F02M 63/00

(52) U.S. Cl. CPC F02M 59/367; F02D 41/22; F02D 2200/0602; F02D 2041/224; F02M 63/005

(57) ABSTRACT

A system for protecting a high-pressure accumulator fuel injection system of an internal combustion engine against excessively high fuel pressures occurring in a high-pressure accumulator of the fuel injection system caused by a malfunction in the fuel injection, wherein the system comprises a member measuring the fuel pressure inside the high-pressure accumulator and sending information about this pressure to a control unit. An electrically controllable inlet valve to a pumping element of a high-pressure pump is included in the system and controlled by the control unit to be transferred to a continuously open or closed state, if the pressure measured exceeds a predetermined pressure level for stopping the feeding of fuel by the pumping element to the high-pressure accumulator.

### CROSS-REFERENCE TO RELATED APPLICATION(S)

This application is a national stage application (filed under 35 § U.S.C. 371) of PCT/SE2017/050084, filed Feb. 2, 2017 of the same title, which, in turn claims priority to Swedish Application No. 1650302-1, filed Mar. 7, 2016 of the same title; the contents of each of which are hereby incorporated by reference.

### FIELD OF THE INVENTION

The present invention relates to an arrangement for protecting a high-pressure accumulator fuel injection system of an internal combustion engine against excessively high fuel pressures occurring in a high-pressure accumulator of the fuel injection system caused by a malfunction in the fuel injection system.

### BACKGROUND OF THE INVENTION

In a high-pressure accumulator fuel injection system of the type defined in the introduction a high-pressure pump pressurizes fuel sent to be accumulated in the high-pressure accumulator, normally called common rail, since it will be shared by a plurality of injectors intended to inject the fuel into a cylinder each of the engine, although the invention also covers the case of only one cylinder of the internal combustion engine.

The occurrence of a malfunction in said system may theoretically cause a pressure inside the high-pressure accumulator rising to unacceptable levels and then destroying parts of the system, and this has of course to be avoided. This is the reason for providing a said arrangement. It is known to connect a safety valve to the high-pressure accumulator opening and draining fuel to a fuel reservoir container as of a certain “over pressure” in the high-pressure accumulator. However, such a safety valve is rather costly.

An arrangement having such a safety valve is known through for instance US 2015/0013642 A1.

### SUMMARY OF THE INVENTION

The object of the present invention is to provide an arrangement and a method of the type defined in the introduction being improved in at least some aspect with respect to such arrangements and methods already known.

This object is with respect to the arrangement obtained by providing such an arrangement with the features listed in the claims.

Thus, the invention is based on including said electrically controllable inlet valves (plural is used hereinafter although it may be only one such valve in the case of one pumping element) in said arrangement and measuring the fuel pressure inside the high-pressure accumulator and controlling the energization of the inlet valves to stop and by that transferring them to a continuously closed or open state and stop the feeding of fuel by the pumping element to the high-pressure accumulator when the value of a pressure measured in the high-pressure accumulator exceeds a predetermined level. Thus, this combination of fuel pressure measuring member and the electrically controllable inlet valves to the pumping elements has replaced said security valve, so that the costs thereof may be saved. It is noticed that said electrically controlled inlet valves may be of two different types, i.e. those that are normally closed, which means that they are closed when not energized, and those, which are normally open when not energized. In both cases the pumping elements may not pump as soon as the valves assume said continuously closed or open state.

According to an embodiment of the invention, the arrangement comprises two said members configured to measure the fuel pressure inside the high-pressure accumulator and to send information about the pressure measured to said control unit so as to obtain redundancy. This redundancy increases the high reliability of an arrangement according to the present invention even more.

According to another embodiment of the invention the arrangement further comprises an irreversible valve arranged in a fuel return line from the high-pressure accumulator to a fuel reservoir container, and that this irreversible valve is configured to be closed at normal operation of said system and to assume an irreversible open state as of a pressure in the high-pressure accumulator above a predetermined level exceeding normal operation fuel pressures in the high-pressure accumulator so as to form a bypass passing the injector and draining fuel from the high-pressure accumulator to the fuel reservoir container and by that reducing the pressure inside the high-pressure accumulator. The arrangement of such an irreversible valve in said fuel return line from the high-pressure accumulator makes an occurrence of a fuel pressure above said predetermined level in the high-pressure accumulator impossible, since the irreversible valve will assume an irreversible open state as soon as said predetermined pressure level is reached.

According to another embodiment of the invention, constituting a further development of the embodiment last mentioned said irreversible valve comprises a member breaking upon action of fuel of a pressure above a predetermined level thereupon and when broken making the irreversible valve irreversibly open. This constitutes a simple and low-cost way of obtaining the irreversibility of said valve.

According to another embodiment of the invention, the control unit is configured to compare said pressure measured with a predetermined level exceeding normal operation fuel pressure in the high-pressure accumulator by 10%-50%, preferably 10%-30%. It is suitable to have said predetermined level exceeding normal operation fuel pressure in the high-pressure accumulator by at least 10%, since the arrangement may otherwise stop the operation of the internal combustion engine due to pressure fluctuations in the system without occurrence of any real malfunction. However, the predetermined level shall preferably be lower than 50% or 30% of normal operation fuel pressure for ensuring that no part of the system may be destroyed.

According to another embodiment of the invention, the irreversible valve is configured to assume an irreversible open state as of a pressure in the high-pressure accumulator above a predetermined level exceeding normal operation fuel pressure in the high-pressure accumulator by 10%-50% or 10%-30%. The reasons for having this predetermined level for the irreversibility of the irreversible valve are the same as those mentioned in the previous paragraph.

The object of the present invention is with respect to the method obtained by providing a method according to the appended independent method claim. The advantages of such a method appear clearly from the above discussion of embodiments of the arrangement according to the invention.

Further advantageous features as well as advantages of the present invention appear from the description following below.

The invention is not restricted to arrangements for protecting a high-pressure accumulator fuel injection system for injection of any particular fuel, but diesel and ethanol may be mentioned by way of examples. Furthermore, the invention relates to such arrangements for internal combustion engines intended for all types of use, such as industrial applications, crushing machines and in all types of motor vehicles, although the invention is particularly applicable to wheeled motor vehicles, especially utility vehicles, such as trucks and busses, and it will for that sake mainly be discussed for this use so as to illuminate the invention but not in any way restrict it thereto.

### BRIEF DESCRIPTION OF THE DRAWINGS

With reference to the appended drawings, below follows a specific description of an embodiment of the invention cited as an example.

In the drawings:

FIG. 1 is a schematic view illustrating an arrangement for protecting a high-pressure accumulator fuel injection system of an internal combustion engine according to an embodiment of the invention,

FIG. 2 is a flow chart illustrating the steps of a method according to the invention, and

FIG. 3 illustrates schematically an electronic control unit according to the invention.

### DETAILED DESCRIPTION OF THE INVENTION

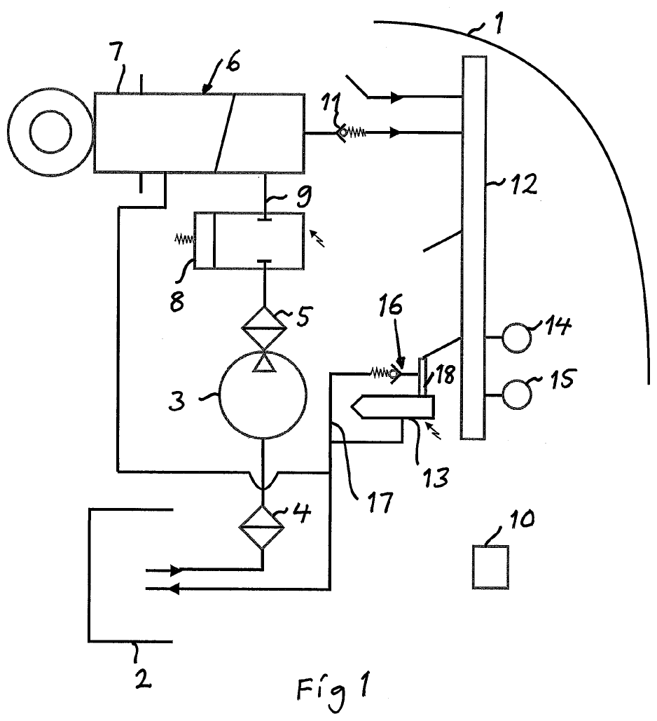

FIG. 1 illustrates schematically the general structure of a high-pressure accumulator fuel injection system of an internal combustion engine arranged in a motor vehicle 1 according to an embodiment of the invention. The high-pressure accumulator fuel injection system is provided with fuel from a fuel reservoir container 2 fed therethrough by a low-pressure feeder pump 3 through filters 4 and 5. A high-pressure pump 6 may have a plurality of pumping elements, normally 2 or 3, but only one 7 is shown here. An electrically controllable inlet valve 8 is arranged in a fuel line 9 to each pumping element 7.

An electronic control unit 10 is configured to control the open degree of said inlet valve 8 by the degree or energization thereof, and the inlet valve is configured to need a supply of voltage from the control unit either for open or closing at all depending upon whether the inlet valve is of the type normally closed or normally open, so that it will either close or open the fuel supply to the pumping element 7 of the high-pressure pump would the supply of voltage thereto be interrupted.

The pumping element 7 will when supplied by fuel from the container 2 through the feeder pump 3 rise the pressure of the fuel and pump fuel through an outlet valve 11 to a high-pressure accumulator 12 (rail) in common to all the cylinders of said internal combustion engine. In the case of a normally open inlet valve 8 this has of course to be energized to close under a part of the pumping stroke of the pumping element 7 for enabling pumping. The pressure of the fuel inside the high-pressure accumulator is for a motor vehicle in the form of a truck typically in the order of 2 000 bar. One injector 13 for each cylinder of said engine is connected to the high-pressure accumulator 12 for being controlled to inject fuel into said cylinder where the fuel is combusted to provide power, such as to a vehicle.

It is shown how two members 14, 15 are provided for measuring the fuel pressure inside the high-pressure accumulator 12 and to send information about the pressure measured to the control unit 10. The control unit 10 is configured to compare the values of this pressure measurement with a predetermined pressure level and if one of these values exceeds said predetermined level the control unit will stop the supply of voltage to said inlet valves and by that transfer these valves to a continuously closed or open state, so that feeding of fuel by the pumping element to the high-pressure accumulator will be stopped.

An irreversible valve 16 is arranged in a fuel return line 17 from the high-pressure accumulator 12 to the fuel reservoir container 2 and is configured to be closed at normal operation of the system. However, this irreversible valve comprises a member 18, such as a rod, breaking as of a pressure in the high-pressure accumulator above a predetermined level acting thereupon and when broken making the irreversible valve 16 irreversibly open so as to form a bypass passing the injector 13 and draining fuel from the high-pressure accumulator to the fuel reservoir container and by that reducing the pressure inside the high-pressure accumulator.

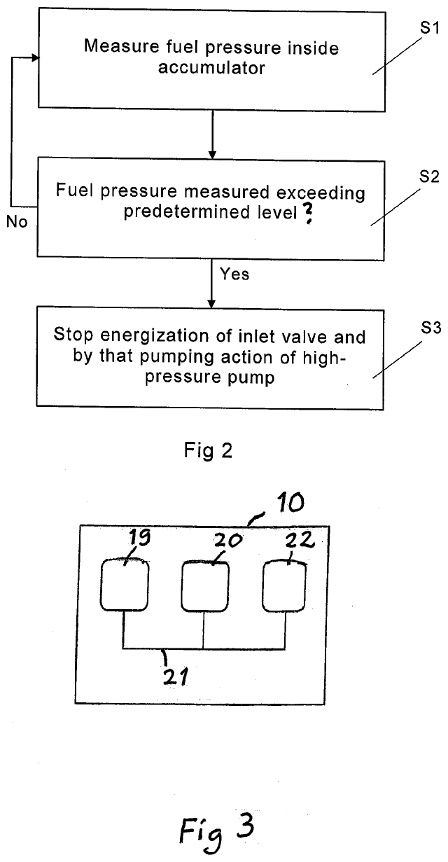

FIG. 2 illustrates a flow chart of a method according to an embodiment of the present invention carried out for protecting a high-pressure accumulator fuel injection system of an internal combustion engine of the type shown in FIG. 1 against excessively high fuel pressures to result in a high-pressure accumulator of that system as a consequence of occurrence of a malfunction in the system. The method is started with a step S1 of measuring the fuel pressure inside the high-pressure accumulator, whereupon in a step S2 the value of the pressure measured is compared with a predetermined level thereof and the question is asked whether the value exceeds said predetermined level. If the answer to this question is yes it is continued with a step S3 of controlling energization of the inlet valve to the pumping element of the high-pressure pump to stop.

Computer program code for implementing a method according to the invention is with advantage included in a computer program, which can be read into the internal memory of a computer, e.g. the internal memory of an electronic control unit of a motor vehicle. Such a computer program is with advantage provided via a computer program product comprising a data storage medium, which can be read by a computer and which has the computer program stored on it. Said data storage medium is for example an optical data storage medium in the form of a CD ROM disc, a DVD disc etc., a magnetic data storage medium in the form of a hard disc, a diskette, a cassette tape etc., or a flash memory or a memory of the ROM, PROM, EPROM or EEPROM type. FIG. 3 illustrates very schematically an electronic control unit 10 comprising an execution means 19, e.g. a central processor unit (CPU), for execution of computer software. The execution means 19 communicates with a memory 20, e.g. of the RAM type, via a data bus 21. The control unit 18 comprises also a non-transitory data storage medium 22, e.g. in the form of a flash memory or a memory of the ROM, PROM, EPROM or EEPROM type. The execution means 19 communicates with the data storage medium 22 via the data bus 21. A computer program comprising computer program code for implementing a method according to the invention, e.g. in accordance with the embodiment illustrated in FIG. 2, is stored on the data storage medium 22.

The invention is of course in no way restricted to the embodiments described above, since many possibilities for modifications thereof are likely to be obvious to one skilled in the art without having to deviate from the scope of invention defined in the appended claims.

1. A system for protecting a high-pressure accumulator fuel injection system of an internal combustion engine against excessively high fuel pressures occurring in a high-pressure accumulator of the fuel injection system caused by a malfunction in the fuel injection system, where the fuel injection system comprises: the high-pressure accumulator, a high-pressure pump with at least one pumping element configured to feed fuel to the high-pressure accumulator, at least one injector connected to the high-pressure accumulator for injecting fuel into a cylinder of the engine, an electrically controllable inlet valve arranged in a fuel line to each of said at least one pumping element and controllable to open and close when energized, said system comprising:
at least one first member configured to measure a fuel pressure inside the high-pressure accumulator;
a control unit configured to compare the value of said pressure measured by said at least one first member with a predetermined pressure level and control energization of the inlet valve to stop and transfer the inlet valve to a continuously closed or open state and stop feeding of fuel by the pumping element to the high-pressure accumulator, when the value of the pressure measured exceeds said predetermined pressure level; and
an irreversible valve arranged in a fuel return line from the high-pressure accumulator to a fuel reservoir container, wherein said irreversible valve is configured to be closed at a normal operation of said fuel injection system and to transition to an irreversible open state when a pressure in the high-pressure accumulator exceeds the predetermined level, so as to form a bypass passing the injector and draining fuel from the high-pressure accumulator to the fuel reservoir container, thereby reducing the pressure inside the high-pressure accumulator.

2. A system according to claim 1, wherein said irreversible valve comprises at least one second member, configured to break when a fuel pressure above a predetermined level acts on the second member and when broken, makes the irreversible valve irreversibly open.

3. A system according to claim 1, further comprising two said first members configured to measure the fuel pressure inside the high-pressure accumulator and to send information about the pressure measured to said control unit, whereby the two said first members provide redundancy.

4. A system according to claim 1, wherein the control unit is configured to compare said pressure measured with said predetermined pressure level, where said predetermined pressure level exceeds a normal operation fuel pressure in the high-pressure accumulator by a value of 10%-50%.

5. A system according to claim 1, wherein the irreversible valve is configured to transition to an irreversible open state when a pressure in the high-pressure accumulator is above a predetermined level, where said predetermined pressure level is a value that exceeds a normal operation fuel pressure in the high-pressure accumulator by a value of 10%-50%.

6. (canceled)

7. (canceled)

8. A system according to claim 1, wherein the control unit is configured to compare said pressure measured with said predetermined pressure level, where said predetermined pressure level exceeds a normal operation fuel pressure in the high-pressure accumulator by a value of 10%-30%.

9. A system according to claim 1, wherein the irreversible valve is configured to transition to an irreversible open state when a pressure in the high-pressure accumulator is above a predetermined level, where said predetermined pressure level is a value that exceeds a normal operation fuel pressure in the high-pressure accumulator by a value of 10%-30%.

10. An internal combustion engine comprising at least one cylinder and a system for protecting a high-pressure accumulator fuel injection system of the internal combustion engine against excessively high fuel pressures occurring in a high-pressure accumulator of the fuel injection system caused by a malfunction in the fuel injection system, where the fuel injection system comprises: the high-pressure accumulator, a high-pressure pump with at least one pumping element configured to feed fuel to the high-pressure accumulator, at least one injector connected to the high-pressure accumulator for injecting fuel into a cylinder of the engine, an electrically controllable inlet valve arranged in a fuel line to each of said at least one pumping element and controllable to open and close when energized, said system comprising:
at least one first member configured to measure a fuel pressure inside the high-pressure accumulator;
a control unit configured to compare the value of said pressure measured by said at least one first member with a predetermined pressure level and control energization of the inlet valve to stop and transfer the inlet valve to a continuously closed or open state and stop feeding of fuel by the pumping element to the high-pressure accumulator, when the value of the pressure measured exceeds said predetermined pressure level; and
an irreversible valve arranged in a fuel return line from the high-pressure accumulator to a fuel reservoir container, wherein said irreversible valve is configured to be closed at a normal operation of said fuel injection system and to transition to an irreversible open state when a pressure in the high-pressure accumulator exceeds the predetermined level, so as to form a bypass passing the injector and draining fuel from the high-pressure accumulator to the fuel reservoir container, thereby reducing the pressure inside the high-pressure accumulator.

11. A motor vehicle comprising:
an internal combustion engine comprising at least one cylinder; and
a system for protecting a high-pressure accumulator fuel injection system of the internal combustion engine against excessively high fuel pressures occurring in a high-pressure accumulator of the fuel injection system caused by a malfunction in the fuel injection system, where the fuel injection system comprises: the high-pressure accumulator, a high-pressure pump with at least one pumping element configured to feed fuel to the high-pressure accumulator, at least one injector connected to the high-pressure accumulator for injecting fuel into a cylinder of the engine, an electrically controllable inlet valve arranged in a fuel line to each of said at least one pumping element and controllable to open and close when energized, said system comprising:
at least one first member configured to measure a fuel pressure inside the high-pressure accumulator;
a control unit configured to compare the value of said pressure measured by said at least one first member with a predetermined pressure level and control energization of the inlet valve to stop and transfer the inlet valve to a continuously closed or open state and stop feeding of fuel by the pumping element to the high-pressure accumulator, when the value of the pressure measured exceeds said predetermined pressure level; and
an irreversible valve arranged in a fuel return line from the high-pressure accumulator to a fuel reservoir container, wherein said irreversible valve is configured to be closed at a normal operation of said fuel injection system and to transition to an irreversible open state when a pressure in the high-pressure accumulator exceeds the predetermined level, so as to form a bypass passing the injector and draining fuel from the high-pressure accumulator to the fuel reservoir container, thereby reducing the pressure inside the high-pressure accumulator.
